(19) United States
(12) Patent Application Publication
(10) Pub. No.: US 2011/0098418 A1
(43) Pub. Date: Apr. 28, 2011

(54) Additives For Detergents And Cleaning Agents

(75) Inventors: Roman Morschhaeuser, Mainz (DE); Frank-Peter Lang, Hattersheim (DE); Steve Laborda, Hofheim (DE); Georg Borchers, Bad Nauheim (DE); Michael Seebach, Hofheim (DE); Sven Gebhard, Liederbach (DE)

(73) Assignee: CLARIANT FINANCE (BVI) LIMITED, Tortola (VG)

(21) Appl. No.: 12/992,389

(22) PCT Filed: May 2, 2009
(86) PCT No.: PCT/EP09/03169

§ 371 Date: Dec. 21, 2010

(30) Foreign Application Priority Data
May 15, 2008 (DE) 102008023803.1
May 2, 2009 (EP) PCT/EP2009/003169

(51) Int. Cl. C08G 63/672

(52) U.S. Cl. 525/437

(57) ABSTRACT

The invention relates to additives in the form of non-ionic polyesters comprising terephthalic acid, ethylene glycol, polyethylene glycol, optionally propylene glycol, C—C-alkyl-polyalkene glycol ether, and a multifunctional cross-linked monomer. Said polyesters preferably have a flow factor ff of greater than 8, and preferably have a melting point of over 40° C. and molecular weights Mp of 4,000 to 15,000 g/mol. Said polyesters are suitable as soil release components in detergents and cleaning agents.

This invention relates to additives for washing and cleaning compositions in the form of polyesters in solid, powder-flowable form, comprising structural units derived from terephthalic acid, dimethyl terephthalate, ethylene glycol, propylene glycol, polyethylene glycols, polyalkylene glycol monoalkyl ethers, and also polyfunctional monomers having a crosslinking action. These polyesters preferably have a melting temperature above 40° C., a flow factor ff, of >8 and a molecular weight Mₚ in the range from 4000 to 16 000.

Polyesters prepared from aromatic dicarboxylic acids such as terephthalic acid or isophthalic acid and monomers from the group of diols, such as ethylene glycol, propylene glycol, polyalkylene glycol, and their use as soil release polymers (SRPs) are well known and described in numerous patent documents.

U.S. Pat. No. 3,893,929 describes compositions in the form of an aqueous acidic bath for finishing woven polyester fabrics with SRPs in textile manufacture, wherein the SRPs used were prepared from a dicarboxylic acid and one or more polyglycols, preferably PEG having molecular weights in the range from 1500 to 2000.

DE 3324258 describes polymers composed of polyethylene terephthalate and polyoxyethylene terephthalate units with a molecular weight of 15 000 to 50 000, wherein the molecular weight of the polyethylene glycol unit (PEG) is in the range from 2500 to 5000, and their soil release effect is highlighted therein. The disadvantage of these soil release polymers (SRPs) is that they adsorb not just on the textile surface but also on dye and soil particles which in turn remain adhering to the textile.

U.S. Pat. No. 3,962,152 discloses laundry detergent compositions comprising SRPs comprising ethylene terephthalate and polyethylene glycol and having molecular weights of 40 000 to 50 000. These high molecular weight SRPs are not very water-soluble, and so the on-textile soil release effect is unsatisfactory.

U.S. Pat. No. 4,702,857 claims polyesters comprising ethylene glycol; 1,2-propylene glycol or mixtures thereof; polyethylene glycol having at least 10 glycol units and capped at one end with a short-chain alkyl group, more particularly with a methyl group; a dicarboxylic acid or ester; and optionally alkali metal salts of sulfonated aromatic dicarboxylic acids.

WO 02/18474 describes room temperature liquid, flowable nonionic oligoesters comprising units derived from the monomers dicarboxylic acid, diol and alkylene oxide and their use for cleaning hard surfaces. These oligoesters are sticky and hence unsuitable for solid formulations.

EP 253 567 discloses SRPs formed from terephthalic acid and polyethylene glycols, the molecular weights of which are in the range from 900 to 9000, with the molecular weights of the polyethylene glycol units used ranging from 300 to 3000.

These types of polyesters are liquid or waxily solid yet sticky, or tend to become sticky in storage, and are difficult to handle for solid powder-flowable preparations.

It is an object of the present invention to provide polyesters which provide very good soil release effects and which at the same time are solid, hydrolysis resistant and nonsticky. They shall be compatible with common adjuvant and excipient materials in washing and cleaning compositions and be easy to incorporate into solid formulations. They shall be readily dispersible in water at below 60° C. and become fully effective in washing and cleaning compositions at below 60° C. They shall also be convertible into storage-stable granulates without high energy requirements.

We have found that this object is achieved, surprisingly, by the hereinbelow described additives in the form of polyesters.

The present invention accordingly provides additives for washing and cleaning compositions, obtained by condensation polymerization of an
a) aromatic dicarboxylic acid and/or C₁-C₄-alkyl esters thereof,
b) ethylene glycol,
c) 1,2-propylene glycol,
d) polyethylene glycol having an average molar mass [Mₙ] of 200 to 8000 g/mol,
e) C₁-C₄-alkyl polyalkylene glycol ether having an average molar mass of 200 to 5000 for the polyalkylene glycol ether, and
f) a polyfunctional compound, wherein the molar ratios of components b), c), d), e) and f) based in each case on 1 mol of component a) are from 0.1 to 4 mol for component b), from 0 to 4 mol for component c), from 0.1 to 0.5 mol for component d), from 0 to 0.5 mol for component e) and from 0 to 0.25 mol for component f).

These additives constitute poly- or oligoesters. They are solid at temperatures above 40° C., do not develop any stickiness in storage for several weeks, and they provide an excellent soil release effect. These nonionic polyesters are convertible into granulates of desired particle size distribution.

In preferred additives of the type defined above, the molar ratios of components b), c), d), e) and f) based in each case on 1 mol of component a) are from 1.0 to 2.5 mol for component b), from 0 mol for component c), from 0.1 to 0.4 mol for component d), from 0 to 0.25 mol for component e) and from 0 to 0.2 mol for component f).

In particularly preferred additives, the molar ratios of components b), c), d), e) and f) based in each case on 1 mol of component a) are from 1.0 to 2.5 mol for component b), from 0 mol for component c), from 0.1 to 0.3 mol for component d), from 0 to 0.2 mol for component e) and from 0 to 0.1 mol for component f).

Particular preference is further given to additives wherein component a) is terephthalic acid and/or dimethyl terephthalate.

Particular preference is similarly given to additives wherein the polyethylene glycol d) has an average molar mass [Mn] of 2000 to 7000, more particularly 5000 to 6000 and particularly preferably 6000.

Preference is given to those additives as defined above that have a flow factor ffc of more than 8 and more particularly in the range from 10 to 30.

Preferably, these additives additionally have a melting point (defined as the differential scanning calorimetry peak maximum) of above 40° C., preferably above 50° C. and more particularly above 55° C.

Preference is also given to such additives as defined above which in addition to the flow factor and the melting point as defined above have a molecular weight with a peak maximum Mₚ (from gel permeation chromatography GPC) of 4000 to 16 000 g/mol, measured against narrowly distributed polyethylene glycol standards.

Particular preference is likewise given to additives as defined above where the molecular weights Mp are in the range from 4000 to 15 000 g/mol, preferably in the range from 6000 to 14 000 g/mol, more preferably in the range from 6500 to 13 000 g/mol and even more preferably in the range from 7000 to 12 000 g/mol.

Component e) preferably comprises poly[ethylene glycol-propylene glycol]monomethyl ethers having average molar masses [Mn] of 100 to 2000 g/mol and polyethylene glycol monomethyl ethers of the general form: CH₃—O—(C₂H₄O)ₙ—H where n≧1 to 99, preferably n=1 to 20.

Very particular preference for use as component e) is given to polyalkylene glycol monoalkyl ethers of the general form: CH₃—O—(C₂H₄O)ₙ—H where n=2 to 10.

In addition to linear polyesters, which result from the structural units a), b), c), d) and e), crosslinked or branched polyester structures are also possible within the meaning of the present invention. This is expressed through the presence of a crosslinking polyfunctional compound f).

Preferred examples thereof are citric acid, malic acid, tartaric acid and gallic acid and more preferably 2,2-dihydroxymethylpropionic acid. Preference is further given to polyhydric alcohols such as pentaerythritol, glycerol, sorbitol and trimethylolpropane, or polybasic aliphatic and aromatic carboxylic acids, such as benzene-1,2,3-tricarboxylic acid (hemimellitic acid), benzene-1,2,4-tricarboxylic acid (trimellitic acid) and more preferably benzene-1,3,5-tricarboxylic acid (trimesic acid).

The advantage of these polyesters is that when stored at 0° C. to 40° C. for several months they remain powder flowable and do not display any stickiness whatsoever. They are also readily dispersible in water.

The polyesters of the present invention are synthesized in a conventional manner by first heating the abovementioned components in the presence of a catalyst to temperatures of 160 to about 220° C. using an inert atmosphere at standard pressure. Then, the requisite molecular weights are built in vacuo at temperatures of 160 to about 240° C. by distilling off superstoichiometric amounts of the glycols used. The familiar transesterification and condensation catalysts of the prior art are suitable for the reaction, for example titanium tetraisopropoxide, dibutyltin oxide, alkali or alkaline earth metal alkoxides or antimony trioxide/calcium acetate. For further details concerning the procedure reference is made to EP 442 101.

A preferred process for preparing the polyesters of the present invention comprises condensing the components in a one-pot process wherein the transesterification and condensation catalyst is added prior to heating.

The polyesters of the present invention are of solid consistency and are simple to process into granulates of defined particle sizes.

Granulating the polyesters of the present invention can be effected by the polyesters formed in the course of the synthesis as a melt being solidified by cooling. A possible form of cooling, in principle, is cooling in a gas stream, for example in sprayed cooling towers, prill towers or air-cooled sectors in extrudate pelletization. Preference is given to cooling on cooled surfaces, for example on a flaking roll or a cooling belt. In this case, the melt is applied and consolidated at cooling-surface temperatures of 0-40° C. and preferably 10-30° C.

The resulting flakes, plate fragments or moldings can subsequently be reduced to the desired particle size by grinding and sieving. A whole series of grinding assemblies are suitable for the comminuting step, examples being cutting mills or sieving mills.

The particle size of the granulate prepared in this way is generally in the range of 100 μm-2000 μm, preferably 200 μm-1800 μm and more preferably 300 μm-1200 μm. The bulk density is in the range from 400 to 700 kg/m³. The (powder) flowability of the polyester granulates can be described in terms of the so-called flow factor ffc and Jenike's classification, Typically, the granulates have very good powder flowability, even after storage, and yield flow factors >8.

The present invention also provides for the use of the polyesters of the present invention in washing and cleaning compositions, textile care compositions and compositions for finishing textiles. The polyesters of the present invention endow the textile fibers with significantly improved soil release properties and augment the soil release performance of the other laundry detergent constituents in relation to oily, greasy soils or pigmentary soils to a significant extent.

It can further be advantageous to use the polyesters of the present invention in aftertreatment compositions for laundry, for example in a rinse cycle fabric conditioner.

The washing and cleaning compositions in which the polyesters of the present invention can be used are pulverulent, granular, pasty, gellike or liquid.

Examples thereof are fully built laundry detergents, mild-action laundry detergents, color laundry detergents, wool laundry detergents, net curtain laundry detergents, modular laundry detergents, laundering tablets, stain salts, laundry starches and stiffeners and also ironing aids.

The polyesters of the present invention can also be incorporated into household cleaners, for example all-purpose cleaners, dishwashing detergents, cleaning and care agents for floors and other hard surfaces, for example of plastic, ceramic, glass.

Examples of technical cleaners are plastics cleaners and reconditioners, for example for housings and dashboards, and also cleaners and reconditioners for painted surfaces such as automotive bodywork for example.

The washing, reconditioning and cleaning compositions of the present invention contain at least 0.1% by weight, preferably between 0.1% and 10% by weight and more preferably 0.2% to 3% by weight of the polyesters of the present invention, based on the final formulations.

Depending on their intended use, the formulations can be adapted in their makeup to the nature of the textiles to be treated or washed.

The washing and cleaning compositions of the present invention may contain customary ingredients, such as surfactants, emulsifiers, builders, bleach catalysts and activators, sequestrants, grayness inhibitors, dye transfer inhibitors, dye fixatives, enzymes, optical brighteners and also softening component. Moreover, formulations or parts of the formulation within the meaning of the present invention can be specifically colored and/or perfumed by means of colorants and/or fragrances.

The total concentration of surfactants in the final washing and cleaning formulation can be in the range from 1% to 99% and preferably from 5% to 80% (all % by weight). The surfactants used can be anionic, nonionic, amphoteric and cationic. Mixtures of the surfactants mentioned can also be used. Preferred washing and cleaning formulations contain anionic and/or nonionic surfactants and mixtures thereof with further surfactants.

Useful anionic surfactants include sulfates, sulfonates, carboxylates, phosphates and mixtures thereof. Suitable cations here are alkali metals, for example sodium or potassium, or alkaline earth metals, for example calcium or magnesium, and also ammonium, substituted ammonium compounds, including mono-, di- or triethanolammonium cations, and mixtures thereof. The following types of anionic surfactants are of particular interest:

alkyl ester sulfonates, alkyl sulfates, alkyl ether sulfates, alkylbenzenesulfonates, alkanesulfonates and soaps, as described below.

Alkyl ester sulfonates include linear esters of C₃-C₂₀ carboxylic acids (i.e., fatty acids) which are sulfonated with gaseous SO₃, as described in “The Journal of the American Oil Chemists Society” 52 (1975), pp. 323-329. Suitable starting materials are natural fats such as, for example, tallow, coconut oil and palm oil, but may also be synthetic in nature. Preferred alkyl ester sulfonates, specifically for laundry detergent applications, are compounds of the formula

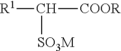

where R¹ is C₈-C₂₀ hydrocarbyl, preferably alkyl, and R is C₁-C₆ hydrocarbyl, preferably alkyl. M is a cation which forms a water-soluble salt with the alkyl ester sulfonate. Suitable cations are sodium, potassium, lithium or ammonium cations, such as monoethanolamine, diethanolamine and triethanolamine. Preferably, R¹ is C₁₀-C₁₆ alkyl and R is methyl, ethyl or isopropyl. Particular preference is given to methyl ester sulfonates in which R¹ is C₁₀-C₁₆ alkyl.

Alkyl sulfates are here water-soluble salts or acids of the formula ROSO₃M, in which R is a C₁₀-C₂₄-hydrocarbon radical, preferably an alkyl or hydroxyalkyl radical with C₁₀-C₂₀-alkyl component, particularly preferably a C₁₂-C₁₈-alkyl or hydroxyalkyl radical. M is hydrogen or a cation, e.g. an alkali metal cation (e.g. sodium, potassium, lithium) or ammonium or substituted ammonium, e.g. methyl-, dimethyl- and trimethylammonium cations and quaternary ammonium cations, such as tetramethylammonium and dimethylpiperidinium cations and quaternary ammonium cations, derived from alkylamines such as ethylamine, diethylamine, triethylamine and mixtures thereof. Alkyl chains with C₁₂-C₁₆ are preferred for low washing temperatures (e.g. below about 50° C.) and alkyl chains with C₁₆-C₁₈ are preferred for higher washing temperatures (e.g. above about 50° C.).

Alkyl ether sulfates are water-soluble salts or acids of the formula RO(A)ₘSO₃M, in which R is an unsubstituted C₁₀-C₂₄-alkyl or hydroxyalkyl radical, preferably a C₁₂-C₂₀-alkyl or hydroxyalkyl radical, particularly preferably C₁₂-C₁₈-alkyl or hydroxyalkyl radical. A is an ethoxy or propoxy unit, m is a number greater than 0, preferably between about 0.5 and about 6, particularly preferably between about 0.5 and about 3 and M is a hydrogen atom or a cation, such as, for example, sodium, potassium, lithium, calcium, magnesium, ammonium or a substituted ammonium cation. Specific examples of substituted ammonium cations are methyl, dimethyl, trimethyl ammonium and quaternary ammonium cations, such as tetramethylammonium and dimethylpiperidinium cations, and also those which are derived from alkylamines, such as ethylamine, diethylamine, triethylamine, or mixtures thereof. Examples which may be mentioned are C₁₂- to C₁₈-fatty alcohol ether sulfates, where the content of EO is 1, 2, 2.5, 3 or 4 mol per mol of the fatty alcohol ether sulfate, and in which M is sodium or potassium.

In secondary alkanesulfonates, the alkyl group can either be saturated or unsaturated, branched or linear and optionally substituted by a hydroxyl group. The sulfo group can be at any desired position on the carbon chain, the primary methyl groups at the chain start and chain end having no sulfonate groups. The preferred secondary alkanesulfonates comprise linear alkyl chains having about 9 to 25 carbon atoms, preferably about 10 to about 20 carbon atoms and particularly preferably about 13 to 17 carbons atoms. The cation is, for example, sodium, potassium, ammonium, mono-, di- or triethanolammonium, calcium or magnesium, and mixtures thereof. Sodium as cation is preferred.

Besides secondary alkanesulfonates, it is also possible to use primary alkanesulfonates in the washing and cleaning compositions according to the invention. The preferred alkyl chains and cations correspond to those of the secondary alkanesulfonates.

The preparation of primary alkanesulfonic acid from which the corresponding sulfonates effective as surfactant are obtained is described, for example, in EP 854 136 A1.

Further suitable anionic surfactants are alkenyl- or alkylbenzenesulfonates. The alkenyl or alkyl group can be branched or linear and optionally substituted by a hydroxyl group. The preferred alkylbenzenesulfonates comprise linear alkyl chains having about 9 to 25 carbon atoms, preferably from about 10 to about 13 carbon atoms, the cation is sodium, potassium, ammonium, mono-, di- or triethanolammonium, calcium or magnesium and mixtures thereof. For mild surfactant systems, magnesium is preferred as cation, whereas for standard washing applications, sodium is preferred. The same is true for alkenylbenzenesulfonates.

The term anionic surfactants also includes olefinsulfonates which are obtained by sulfonation of C₁₂-C₂₄-, preferably C₁₄-C₁₆-α-olefins with sulfur trioxide and subsequent neutralization. As a result of the preparation process, these olefinsulfonates can comprise relatively small amounts of hydroxyalkanesulfonates and alkanedisulfonates. Specific mixtures of α-olefin sulfonates are described in U.S. Pat. No. 3,332,880.

Further preferred anionic surfactants are carboxylates, e.g. fatty acid soaps and comparable surfactants. The soaps may be saturated or unsaturated and can comprise various substituents, such as hydroxyl groups or α-sulfonate groups. Linear saturated or unsaturated hydrocarbon radicals as hydrophobic moiety with about 6 to about 30, preferably about 10 to about 18, carbon atoms are preferred.

Suitable anionic surfactants are also salts of acylaminocarboxylic acids, the acyl sarcosinates which form by reacting fatty acid chlorides with sodium sarcosinate in an alkaline medium; fatty acid-protein condensation products which are obtained by reacting fatty acid chlorides with oligopeptides; salts of alkylsulfamidocarboxylic acids; salts of alkyl- and alkylaryl ether carboxylic acids; C₈-C₂₄-olefinsulfonates, sulfonated polycarboxylic acids, prepared by sulfonation of the pyrolysis products of alkaline earth metal citrates, as described, for example, in GB-1,082,179; alkylglycerol sulfates, oleylglycerol sulfates, alkylphenol ether sulfates, primary paraffinsulfonates, alkyl phosphates, alkyl ether phosphates, isethionates, such as acyl isethionates, N-acyltaurides, alkyl succinates, sulfosuccinates, monoesters of the sulfosuccinates (particularly saturated and unsaturated C₁₂-C₁₈-monoesters) and diesters of sulfosuccinates (particularly saturated and unsaturated C₁₂-C₁₈-diesters), acyl sarcosinates, sulfates of alkyl polysaccharides, such as sulfates of alkyl polyglycosides, branched primary alkyl sulfates and alkyl polyethoxycarboxylates, such as those with the formula RO(CH₂CH₂)ₖCH₂COO⁻M⁺, in which R is C₈ to C₂₂-alkyl, k is a number from 0 to 10 and M is a cation, resin acids or hydrogenated resin acids, such as rosin or hydrogenated rosin or tall oil resins and tall oil resin acids.

Suitable nonionic surfactants are, for example, the following compounds: polyethylene, polypropylene and polybutylene oxide condensates of alkylphenols.

These compounds include the condensation products of alkylphenols with a C₆- to C₂₀-alkyl group, which may either be linear or branched, with alkene oxides. Preference is given to compounds with about 5 to 25 mol of alkene oxide per mol of alkylphenol. Commercially available surfactants of this type are, for example, Igepal® CO-630, Triton® X-45, X-114, X-100 and X102, and the ®Arkopal-N brands of Clariant GmbH. These surfactants are referred to as alkylphenol alkoxylates, e.g. alkylphenol ethoxylates.

Condensation products of aliphatic alcohols with about 1 to about 25 mol of ethylene oxide.

The alkyl chain of the aliphatic alcohols can be linear or branched, primary or secondary, and generally comprises about 8 to about 22 carbon atoms. Particular preference is given to the condensation products of C₁₀- to C₂₀-alcohols with about 2 to about 18 mol of ethylene oxide per mol of alcohol. The alkyl chain can be saturated or unsaturated. The alcohol ethoxylates can have a narrow homolog distribution of the ethylene oxide (“narrow range ethoxylates”) or a broad homolog distribution of the ethylene oxide (“broad range ethoxylates”). Examples of commercially available nonionic surfactants of this type are Tergitol® 15-S-9 (condensation product of a linear secondary C₁₁-C₁₅-alcohol with 9 mol of ethylene oxide), Tergitol® 24-L-NMW (condensation product of a linear primary C₁₂-C₁₄-alcohol with 6 mol of ethylene oxide in the case of narrow molecular weight distribution). The Genapol® brands of Clariant GmbH likewise fall under this product class.

Condensation products of ethylene oxide with a hydrophobic basis, formed by condensation of propylene oxide with propylene glycol.

The hydrophobic moiety of these compounds preferably has a molecular weight between about 1500 and about 1800. The addition of ethylene oxide onto this hydrophobic moiety leads to an improvement in the water solubility. The product is liquid up to a polyoxyethylene content of about 50% of the total weight of the condensation product, which corresponds to a condensation with up to about 40 mol of ethylene oxide. Commercially available examples of this product class are the Pluronic brands of BASF and the ®Genapol PF brands of Clariant GmbH.

Condensation products of ethylene oxide with a reaction product of propylene oxide and ethylene diamine.

The hydrophobic unit of these compounds consists of the reaction product of ethylene diamine with excess propylene oxide and generally has a molecular weight of from about 2500 to 3000. Ethylene oxide is added onto this hydrophobic unit up to a content of about 40 to about 80% by weight of polyoxyethylene and a molecular weight of about 5000 to 11 000. Commercially available examples of this compound class are the ®Tetronic brands of BASF and the ®Genapol PN brands of Clariant GmbH.

### Semipolar Nonionic Surfactants

This category of nonionic compounds includes water-soluble amine oxides, water-soluble phosphine oxides and water-soluble sulfoxides, each having an alkyl radical of from about 10 to about 18 carbon atoms. Semipolar nonionic surfactants are also amine oxides of the formula

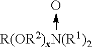

where R is an alkyl, hydroxyalkyl or alkylphenol group with a chain length of from about 8 to about 22 carbon atoms, R² is an alkylene or hydroxyalkylene group having about 2 to 3 carbon atoms or mixtures thereof, each radical R¹ is an alkyl or hydroxyalkyl group having about 1 to about 3 carbon atoms or a polyethylene oxide group having about 1 to about 3 ethylene oxide units, and x is a number from 0 to about 10. The R¹ groups may be joined together via an oxygen or nitrogen atom and thus form a ring. Amine oxides of this type are particularly C₁₀-C₁₈-alkyldimethylamine oxides and C₈-C₁₂-alkoxyethyldihydroxyethylamine oxides.

### Fatty Acid Amides

Fatty acid amides have the formula

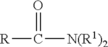

in which R is an alkyl group having about 7 to about 21, preferably about 9 to about 17, carbon atoms, and each radical R¹ is hydrogen, C₁-C₄-alkyl, C₁-C₄-hydroxyalkyl or (C₂H₄O)ₓH, where x varies from about 1 to about 3. Preference is given to C₈-C₂₀-amides, -monoethanolamides, -diethanolamides and -isopropanolamides.

Further suitable nonionic surfactants are alkyl and alkenyl oligoglycosides, and also fatty acid polyglycol esters or fatty amine polyglycol esters having in each case 8 to 20, preferably 12 to 18, carbon atoms in the fatty alkyl radical, alkoxylated triglycamides, mixed ethers or mixed formyls, alkyl oligoglycosides, alkenyl oligoglycosides, fatty acid N-alkylglucamides, phosphine oxides, dialkyl sulfoxides and protein hydrolyzates.

Typical examples of amphoteric and zwitterionic surfactants are alkylbetaines, alkylamidebetaines, aminopropionates, aminoglycinates, or amphoteric imidazolinium compounds of the formula

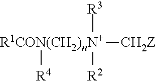

in which R¹ is C₈-C₂₂-alkyl or -alkenyl, R² is hydrogen or CH₂CO₂M, R³ is CH₂CH₂OH or CH₂CH₂OCH₂CH₂CO₂M, R⁴ is hydrogen, CH₂CH₂OH or CH₂CH₂COOM, Z is CO₂M or CH₂CO₂M, n is 2 or 3, preferably 2, M is hydrogen or a cation, such as alkali metal, alkaline earth metal, ammonium or alkanolammonium.

Preferred amphoteric surfactants of this formula are monocarboxylates and dicarboxylates. Examples thereof are cocoamphocarboxypropionate, cocoamidocarboxypropionic acid, cocoamphocarboxyglycinate (or also referred to as cocoamphodiacetate) and cocoamphoacetate.

Further preferred amphoteric surfactants are alkyldimethylbetaines and alkyldipolyethoxybetaines with an alkyl radical having about 8 to about 22 carbon atoms, which may be linear or branched, preferably having 8 to 18 carbon atoms and particularly preferably having about 12 to about 18 carbon atoms. These compounds are marketed, for example, by Clariant GmbH under the trade name ®Genagen LAB.

Suitable cationic surfactants are substituted or unsubstituted straight-chain or branched quaternary ammonium salts of the type R¹N(CH₃)₃^{ρ}X^{σ}, R¹R²N(CH₃)₂^{ρ}X^{σ}, R¹R²R³N(CH₃)^{ρ}X^{σ} or R¹R²R³R⁴N^{ρ}X^{σ}. The radicals R¹, R², R³ and R⁴ can preferably be, independently of one another, unsubstituted alkyl with a chain length between 8 and 24 carbon atoms, in particular between 10 and 18 carbon atoms, hydroxyalkyl having about 1 to about 4 carbon atoms, phenyl, C₂- to C₁₈-alkenyl, C₇- to C₂₄-aralkyl, (C₂H₄O)ₓH, where x is from about 1 to about 3, alkyl radicals containing one or more ester groups, or cyclic quaternary ammonium salts. X is a suitable anion.

In preferred embodiments, the washing and cleaning compositions according to the invention comprise linear alkylbenzenesulfonate. The preferred alkylbenzenesulfonates comprise linear alkyl chains having about 9 to 25 carbon atoms, preferably from about 10 to about 13 carbon atoms, the cation is sodium, potassium, ammonium, mono-, di- or triethanolammonium, calcium or magnesium and mixtures thereof. For mild surfactant systems, magnesium is preferred as cation, whereas for standard washing applications, sodium is preferred.

In likewise preferred embodiments, the washing and cleaning compositions according to the invention comprise secondary alkanesulfonates with linear alkyl chains having about 9 to 25 carbon atoms, preferably about 10 to about 20 carbon atoms and particularly preferably about 13 to 17 carbon atoms. The cation is, for example, sodium, potassium, ammonium, mono-, di- or triethanolammonium, calcium or magnesium, and mixtures thereof. Sodium is preferred as cation.

In likewise preferred embodiments, the washing and cleaning compositions according to the invention comprise alkyl ether sulfates of the formula RO(A)ₘSO₃M, in which R is an unsubstituted C₁₀-C₂₄-alkyl or hydroxyalkyl radical, preferably a C₁₂-C₂₀-alkyl or hydroxyalkyl radical, particularly preferably C₁₂-C₁₈-alkyl or hydroxyalkyl radical. A is an ethoxy or propoxy unit, m is a number greater than 0, preferably between about 0.5 and about 6, particularly preferably between about 0.5 and about 3, and M is a hydrogen atom or a cation such as, for example, sodium, potassium, lithium, calcium, magnesium, ammonium or a substituted ammonium cation. Specific examples of substituted ammonium cations are methyl, dimethyl, trimethylammonium and quaternary ammonium cations such as tetramethylammonium and dimethylpiperidinium cations, and also those which are derived from alkylamines, such as ethylamine, diethylamine, triethylamine or mixtures thereof. Examples which may be mentioned are C₁₂- to C₁₈-fatty alcohol ether sulfates, where the content of EO is 1, 2, 2.5, 3 or 4 mol per mol of the fatty alcohol ether sulfate, and in which M is sodium or potassium.

Suitable emulsifiers are addition products of from 0 to 30 mol of alkylene oxide, in particular ethylene oxide, propylene oxide and/or butylene oxide, onto linear or branched, saturated or unsaturated fatty alcohols having 8 to 22 carbon atoms, onto fatty acids having 12 to 22 carbon atoms, onto alkylphenols having 8 to 15 carbon atoms in the alkyl group and onto sorbitan esters;

(C₁₂-C₁₈)-fatty acid mono- and diesters of addition products of from 0 to 30 mol of ethylene oxide onto glycerol;
glycerol mono- and diesters and sorbitan mono- and diesters of saturated and unsaturated fatty acids having 6 to 22 carbon atoms and optionally ethylene oxide addition products thereof;
addition products of from 5 to 60 mol, preferably 15 to 60 mol, of ethylene oxide onto castor oil and/or hydrogenated castor oil;
polyol, and in particular polyglycerol, esters, such as, for example, polyglycerol polyricinoleate and polyglycerol poly-12-hydroxystearate.

Preference is given to liquid fatty acid esters which may be either ethoxylated (PEG-10 polyglyceryl-2 laurate) and also nonethoxylated (polyglyceryl-2 sesquiisostearate).

Further preferred mixtures according to the invention comprise sorbitol esters prepared by reacting sorbitol with fatty acid methyl esters or fatty acid triglycerides. The fatty acid radical in the fatty acid methyl esters and fatty acid triglycerides contains in general 8 to 22 carbon atoms and can be straight-chain or branched, saturated or unsaturated. Examples thereof are palmitic acid, stearic acid, lauric acid, linoleic acid, linolenic acid, isostearic acid or oleic acid. Suitable fatty acid triglycerides are all native animal or vegetable oils, fats and waxes, for example olive oil, rapeseed oil, palm kernel oil, sunflower oil, coconut oil, linseed oil, castor oil, soybean oil, optionally also in refined or hydrogenated form. Since these natural fats, oils and waxes are normally mixtures of fatty acids with varying chain length, this also applies for the fatty acid radicals in the sorbitol esters used according to the invention. The sorbitol esters used according to the invention can also be alkoxylated, preferably ethoxylated.

Furthermore, anionic emulsifiers, such as ethoxylated and nonethoxylated mono-, di- or triphosphoric acid esters, but also cationic emulsifiers, such as mono-, di- and trialkyl quats and polymeric derivatives thereof, can be used.

Mixtures of compounds from two or more of these substance classes are likewise suitable.

Further washing and cleaning ingredients which may be present in the present invention include inorganic and/or organic builders in order to reduce the degree of hardness of the water.

These builders may be present in weight fractions of from about 5 to about 80% in the washing and cleaning compositions. Inorganic builders include, for example, alkali metal, ammonium and alkanolammonium salts of polyphosphates, such as, for example, tripolyphosphates, pyrophosphates and glass-like polymeric metaphosphates, phosphonates, silicates, carbonates including bicarbonates and sesquicarbonates, sulfates and aluminosilicates.

Examples of silicate builders are the alkali metal silicates, in particular those with an SiO₂:Na₂O ratio between 1.6:1 and 3.2:1, and also sheet silicates, for example sodium sheet silicates, as described in U.S. Pat. No. 4,664,839, obtainable from Clariant GmbH under the brand SKS®. SKS-6® is a particularly preferred sheet silicate builder.

Aluminosilicate builders are particularly preferred for the present invention. These are, in particular, zeolites with the formula Na_{z}[(AlO₂)_{z}(SiO₂)_{y}].xH₂O, in which z and y are integers of at least 6, the ratio of z to y is between 1.0 and about 0.5, and x is an integer of about 15 to about 264.

Suitable ion exchangers based on aluminosilicate are commercially available. These aluminosilicates may be of crystalline or amorphous structure, and may be naturally occurring or else synthetically produced. Processes for the production of ion exchangers based on aluminosilicate are described in U.S. Pat. No. 3,985,669 and U.S. Pat. No. 4,605,509. Preferred ion exchangers based on synthetic crystalline aluminosilicates are obtainable under the name zeolite A, zeolite P(B) (including those disclosed in EP-A-0 384 070) and zeolite X. Preference is given to aluminosilicates with a particle diameter between 0.1 and 10 μm.

Suitable organic builders include polycarboxyl compounds, such as, for example, ether polycarboxylates and oxydisuccinates, as described, for example in U.S. Pat. No. 3,128,287 and U.S. Pat. No. 3,635,830. Reference should likewise be made to “TMS/TDS” builders from U.S. Pat. No. 4,663,071.

Other suitable builders include the ether hydroxypolycarboxylates, copolymers of maleic anhydride with ethylene or vinyl methyl ether, 1,3,5-trihydroxybenzene-2,4,6-trisulfonic acid and carboxymethyloxysuccinic acid, the alkali metal, ammonium and substituted ammonium salts of polyacetic acids, such as, for example, ethylenediaminetetraacetic acid and nitrilotriacetic acid, and also polycarboxylic acids, such as mellitic acid, succinic acid, oxydisuccinic acid, polymaleic acid, benzene-1,3,5-tricarboxylic acid, carboxymethyloxysuccinic acid, and soluble salts thereof.

Builders based on citrates, for example citric acid and its soluble salts, in particular the sodium salt, are preferred polycarboxylic acid builders, which can also be used in granulated formulations, in particular together with zeolites and/or sheet silicates.

Further suitable builders are the 3,3-dicarboxy-4-oxa-1,6-hexanedioates and the related compounds which are disclosed in U.S. Pat. No. 4,566,984.

When builders based on phosphorus can be used, and in particular when soap bars for washing by hand are to be formulated, various alkali metal phosphates, such as, for example, sodium tripolyphosphate, sodium pyrophosphate and sodium orthophosphate, can be used. It is likewise possible to use phosphonate builders, such as ethane-1-hydroxy-1,1-diphosphonate and other known phosphonates, as disclosed, for example, in U.S. Pat. No. 3,159,581, U.S. Pat. No. 3,213,030, U.S. Pat. No. 3,422,021, U.S. Pat. No. 3,400,148 and U.S. Pat. No. 3,422,137.

The washing and cleaning compositions of the present invention can optionally comprise one or more conventional bleaches, and also activators or stabilizers, in particular peroxyacids, which do not react with the polyesters of the invention.

The peroxyacid can either be a free peroxyacid, or a combination of an inorganic persalt, for example sodium perborate or sodium percarbonate, and an organic peroxyacid precursor, which is converted to a peroxyacid when the combination of the persalt and of the peroxyacid precursor is dissolved in water. The organic peroxyacid precursors are often referred to in the prior art as bleach activators.

Examples of peroxyacids which are preferred for use in this invention include peroxydodecanedioic acid (DPDA), the nonylamide of peroxysuccinic acid (NAPSA), the nonylamide of peroxyadipic acid (NAPAA) and decyldiperoxysuccinic acid (DDPSA). The peroxy acid is preferably present in soluble granules, corresponding to the method from U.S. Pat. No. 4,374,035.

Preferred bleach granules comprise, in percentages by weight, 1% to 50% of an exothermically soluble compound, such as, for example, boric acid; 1% to 25% of a surface-active ingredient compatible with the peroxy acid, such as, for example, C13LAS; 0.1% to 10% of one or more chelate stabilizers, such as, for example, sodium pyrophosphate; and 10% to 70% of a water-soluble salt, such as, for example, sodium sulfate.

The peroxyacid-containing bleach is used in amounts which produce an amount of available oxygen of between about 0.1% and about 10%, preferably between about 0.5% and about 5%, in particular from about 1% to 4%. The percentages given refer to the total weight of the cleaning composition.

Suitable amounts of the peroxyacid-containing bleach, based on a unit dose the detergent compositions according to the invention, as is used for a typical wash liquor which comprises about 65 liters of water at 15 to 60° C., produce between about 1 ppm to about 150 ppm of available oxygen, preferably between about 2 ppm to about 20 ppm of available oxygen. The wash liquor should have a pH between 7 and 11, preferably between 7.5 and 10.5, in order to achieve an adequate bleaching result. Reference is made to column 6, lines 1 to 10 of U.S. Pat. No. 4,374,035.

Alternatively, the bleach composition can comprise a suitable organic peroxyacid precursor which produces one of the abovementioned peroxy acids when it reacts with hydrogen peroxide in aqueous alkaline solution. The source of the hydrogen peroxide may be any inorganic peroxide which liberates hydrogen peroxide in aqueous solution, such as, for example, sodium perborate (monohydrate and tetrahydrate) and sodium percarbonate.

Bleach activators that are available are N,N,N′,N′-tetraacetylethylenediamine (TAED), glucose pentaacetate (GPA), xylose tetraacetate (TAX), sodium 4-benzoyloxybenzenesulfonate (SBOBS), sodium trimethyl-hexanoyloxybenzenesulfonate (STHOBS), tetraacetylglucoluril (TAGU), tetraacetylcyanic acid (TACA), di-N-acetyldimethylglyoxine (ADMG) and 1-phenyl-3-acetylhydantoin (PAH), nonanoylcaprolactam phenylsulfonate ester (APES), nonanoylphenyl sulfonate ester (NOPS), nitrilotriacetate (NTA) and ammonium nitriles.

The washing and cleaning compositions according to the invention can comprise one or more conventional enzymes. Such enzymes are, for example, lipases, amylases, proteases, cellulases, pullinases, cutinases, peroxidases. Proteases that are available are BLAP®, Opticlean®, Maxacal®, Maxapem®, Esperase®, Savinase®, Purafect®, OxP and/or Duraxym®, available amylases are Termamyl®, Amylase-LT®, Maxamyl®, Duramyl®, and/or Pruafect® OxAm, available lipases are Lipolase®, Lipomax®, Lumafast® and/or Lipozym®. A preferred enzyme is cellulase. The cellulase used here can be obtained from bacteria or fungi and should have an optimum pH range between 5 and 9.5. Preferred cellulases are described in WO-91/17 243.

Likewise preferred enzymes are lipases which, being fat-cleaving enzymes, permit better detachment of native oils and fats from soiled fabrics and thus assist the polyesters according to the invention in their effect, where generally additive, and also synergistic, effects can be achieved.

The enzymes can be adsorbed to carrier substances and/or embedded in coating substances.

Based on the weight of the washing and cleaning compositions which comprise the polyesters according to the invention, the fraction of enzymes is at least 0.001% by weight, preferably between about 0.001 to about 5% by weight, in particular from about 0.001 to about 1% by weight, specifically from about 0.01 to about 1% by weight.

Sequestrants that are available are sodium tripolyphosphate (STPP), ethylenediaminetetraacetic acid (EDTA), salts, nitrilotriacetic acid (NTA), polyacrylate, phosphonate, oxalic acid, oxalic acid salt, citric acid, zeolite, condensed phosphates, carbonates, polycarbonates.

Suitable grayness inhibitors are carboxymethylcellulose, methylcellulose, hydroxyalkylcellulose, methylhydroxyethylcellulose, methylhydroxypropylcellulose, methylcarboxymethylcellulose and polyvinylpyrrolidone.

Dye transfer inhibitors are also suitable, for example polyamine N-oxides, such as, for example, poly(4-vinylpyridine N-oxide), e.g. Chromabond S-400, ISP; polyvinylpyrrolidone, e.g. Sokalan® HP 50/BASF and copolymers of N-vinylpyrrolidone with N-vinylimidazole and optionally other monomers.

The invention includes washing and cleaning compositions comprising dye fixatives as active substances, for example dye fixatives which are obtained by reacting diethylenetriamine, dicyandiamide and amidosulfuric acid, amines with epichlorohydrin, for example dimethylaminopropylamine and epichlorohydrin or dimethylamine and epichlorohydrin or dicyandiamide, formaldehyde and ammonium chloride, or dicyandiamide, ethylenediamine and formaldehyde or cyanamide with amines and formaldehyde or polyamines with cyanamides and amidosulfuric acid or cyanamides with aldehydes and ammonium salts, but also polyamine N-oxides, such as, for example, poly(4-vinylpyridine N-oxide), e.g. Chromabond S-400, ISP; polyvinylpyrrolidone, e.g. Sokalan® HP 50/BASF and copolymers of N-vinylpyrrolidone with N-vinylimidazole and optionally other monomers.

The washing and cleaning compositions according to the invention can comprise complexing agents, for example aminocarboxylates, such as ethylenediamine tetraacetate, N-hydroxyethylethylenediamine triacetate, nitrilotriacetate, ethylenediamine tetrapropionate, triethylenetetraamine hexaacetate, diethylenetriamine pentaacetate, cyclohexanediamine tetraacetate, phosphonates, for example azacycloheptanediphosphonate, Na salt, pyrophosphates, etidronic acid (1-hydroxyethylidene-1,1-diphosphonic acid, 1-hydroxyethane-1,1-diphosphonic acid, acetophosphonic acid) and its salts, aminophosphonates, such as ethylenediamine tetrakis(methylenephosphonate), diethylenetriamine pentakis(methylenephosphonate), amine trimethylenephosphonic acid, cyclodextrines, and polyfunctionally substituted aromatic complexing agents, such as dihydroxydisulfobenzene or ethylenediamine disuccinates. Optical brighteners which can be used are cyclic hydrocarbons, such as distyrylbenzenes, distyrylbiphenyls, diphenylstilbenes, triazinylamino-stilbenes, stilbenzyl-2H-triazoles, for example stilbenzyl-2H-naphthol[1,2-d]triazoles and bis(1,2,3-triazol-2-yl)stilbenes, benzoxazoles, for example stilbenzylbenzoxazole and bis(benzoxazole), furans, benzofurans and benzimidazoles, for example bis(benzo[b]furan-2-yl)biphenyl and cationic benzimidazoles, 1,3-diphenyl-2-pyrazoline, coumarin, naphthalimides, 1,3,5-2-yl derivatives, methine cyanine and dibenzothiophene 5,5-oxide.

Preference is given to anionic optical brighteners, in particular sulfonated compounds.

Also of suitability are triazinylaminostilbenes, distyrylbiphenyls and mixtures thereof, 2-(4-styrylphenyl)-2H-naphtho[1,2-d]triazole, 4,4′-bis(1,2,3-triazolaminocoumarin, 4-methyl-7-ethylaminocoumarin, 1,2-bis-(benzimidazol-2-yl)ethylene, 1,3-diphenylphrazoline, 2,5-bis(benzooxazol-2-yl)thiophene, 2-styrylnaphtho[1,2-d]oxazole, 2-(4-styryl-3-sulfophenyl)-2H-naphtho[1,2-d]triazole and 2-(stilben-4-yl)-2H-naphthol[1,2-d]triazole.

The laundry detergents according to the invention can comprise optical brighteners in amounts of from 0.001% by weight to 2% by weight, preferably 0.002% by weight to 0.8% by weight, particularly preferably 0.003% by weight to 0.4% by weight.

The softening components used are quaternary ammonium salts of the type

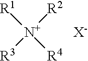

in which
R¹=C₈-C₂₄ n- or isoalkyl, preferably C₁₀-C₁₈ n-alkyl
R²=C₁-C₄-alkyl, preferably methyl

### R³=R¹ or R²

R⁴=R² or hydroxyethyl or hydroxypropyl or oligomers thereof
X⁻=bromide, chloride, iodide, methosulfate, acetate, propionate, lactate.

Examples thereof are distearyldimethylammonium chloride, ditallow-alkyldimethylammonium chloride, ditallowalkylmethylhydroxypropylammonium chloride, cetyltrimethylammonium chloride or else the corresponding benzyl derivatives, such as, for example, dodecyldimethylbenzylammonium chloride. Cyclic quaternary ammonium salts, such as, for example, alkylmorpholine derivatives, can likewise be used.

Moreover, besides the quaternary ammonium compounds, imidazolinium compounds (1) and imidazoline derivatives (2) can be used.

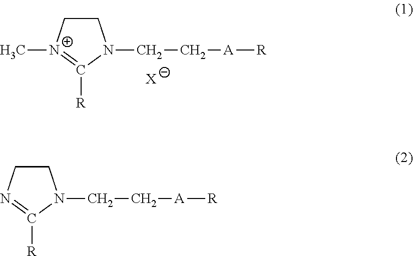

in which
R=C₈-C₂₄ n- or isoalkyl, preferably C₁₀-C₁₈ n-alkyl
X=bromide, chloride, iodide, methosulfate

### A=—NH—CO—, —CO—NH—, —O—CO—, —CO—O—.

A particularly preferred compound class is the so-called ester quats. These are reaction products of alkanolamines and fatty acids, which are then quaternized with customary alkylating or hydroxyalkylating agents.

Preferred alkanolamines are compounds according to the formula

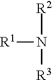

where
R¹=C₁-C₃ hydroxyalkyl, preferably hydroxyethyl and
R², R³=R¹ or C₁-C₃ alkyl, preferably methyl.

Particular preference is given to triethanolamine and methyldiethanolamine.

Further particularly preferred starting materials for ester quats are aminoglycerol derivatives, such as, for example, dimethylaminopropanediol. Alkylation and hydroxyalkylation agents are alkyl halides, preferably methyl chloride, dimethyl sulfate, ethylene oxide and propylene oxide.

Examples of ester quats are compounds of the formulae:

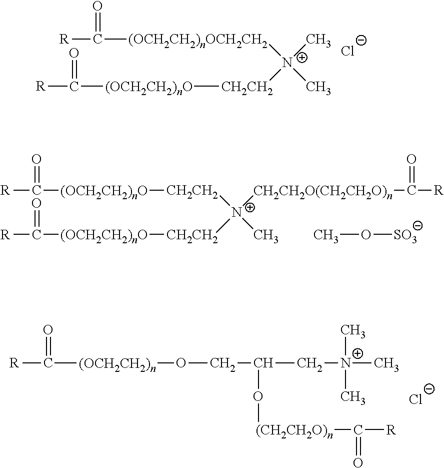

where R—C—O is derived from C₈-C₂₄-fatty acids which may be saturated or unsaturated. Examples thereof are caproic acid, caprylic acid, hydrogenated or unhydrogenated or only partially hydrogenated tallow fatty acids, stearic acid, oleic acid, linolenic acid, behenic acid, palmitostearic acid, myristic acid and elaidic acid. n is in the range from 0 to 10, preferably 0 to 3, particularly preferably 0 to 1.

Further preferred fabric softener raw materials with which the polyesters according to the invention can be combined are amidoamines based on, for example, dialkyltriamines and long-chain fatty acids, and their oxethylates or quaternized variants. These compounds have the following structure:

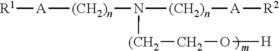

in which
R¹ and R² independently of one another are C₈-C₂₄ n- or isoalkyl, preferably C₁₀-C₁₈ n-alkyl,
A is —CO—NH— or —NH—CO—,
n is 1-3, preferably 2,
m is 1-5, preferably 2-4.

By quaternizing the tertiary amino group, it is additionally possible to introduce a radical R³, which may be C₁-C₄-alkyl, preferably methyl, and a counterion X, which may be chloride, bromide, iodide or methyl sulfate. Amidoaminooxethylates and their quaternized secondary products are supplied under the trade names ®Varisoft 510, ®Varisoft 512, ®Rewopal V 3340 and ®Rewoquat W 222 LM.

The preferred use concentrations of the polyesters used of the present invention in the rinse cycle fabric conditioner formulations correspond to those specified for laundry detergent formulations.

The washing and cleaning compositions of the present invention preferably include colorants and fragrance/perfume materials.

Preference is given to using solutions or emulsions of the above-mentioned fragrances and perfume oils, which are obtainable in a conventional manner.

The present invention further provides solid dishwashing compositions comprising the above-defined polyesters. Concerned here are compositions for cleaning glass, porcelain, cutlery, metal and plastics articles in a dishwasher. The polyesters conforming to the present invention effectuate very good runoff on the part of the washing and rinsing water at the surfaces of the articles mentioned. This shortens the drying time in the dishwasher, and residueless and spotless ware is achieved. Moreover, these polyesters are very readily water-soluble and thereby permit a reduction in the amount of washing water.

The level in solid mechanical dishwashing formulations of polyesters used according to the present invention can vary within wide limits and is generally in the range from 0.1% to 10% by weight, preferably in the range from 0.5% to 5% by weight and more preferably in the range from 1% to 3% by weight based on the particular formulation.

The solid mechanical dishwashing compositions can be provided as powders, granulates or in the form of tablets.

Producing the solid dishwashing compositions of the present invention presents no difficulties and can be effected in a known manner. The powder- or granulate-shaped compositions of the present invention can be effected by simply mixing the powder- or granulate-shaped polyesters with the further ingredients of the dishwashing formulation in the appropriate use quantities.

The solid dishwashing compositions can also be offered as extruded moldings. In this case, a solid and essentially powder-flowable mixture of the ingredients or some of the ingredients of the dishwashing formulation is extruded under pressure as a strand which, after emerging from the hole shape, is cut by a cutting device to the predeterminable granulate size.

A preferred embodiment of the present invention comprises dishwashing compositions in tablet form, which can be monophasic or polyphasic, single-colored or multicolored and can more particularly consist of one layer or more than one layer, especially of two layers.

The preferred procedure is to mix all the constituents—of each layer in the case of two or more layers—with one another in a mixer and to mold the mixture by means of conventional tableting presses, for example eccentric presses or rotary presses. Particularly in the case of multilayered tablets, it can be advantageous for at least one layer to be premolded.

Preferably, a tablet produced in this way has a weight of 10 g to 50 g, more particularly in the range from 15 g to 40 g. The three-dimensional shape of the tablets is freely choosable and can be round, oval or angular, although intermediate shapes are also possible. Corners and edges are advantageously rounded off. Round tablets preferably are from 30 mm to 40 mm in diameter. Particularly the size of angular- or cuboid-shaped tablets, which are predominantly introduced via the dosing device of the dishwasher for example, is dependent on the geometry and the capacity of this dosing device. Illustratively preferred embodiments have a base area of (20 to 30 mm)×(34 to 40 mm), more particularly of 26×36 mm or of 24×38 mm.

The dishwashing compositions in tablet form may contain tablet disintegrants. Substances contemplated are such as starch, cellulose and cellulose derivatives, alginates, dextrans, crosslinked polyvinylpyrrolidones and also systems composed of weak acids and carbonate-containing agents, for example citric acid and tartaric acid combined with bicarbonate or carbonate, but also finely divided and swellable sheet silicates of the bentonites and smectites kind. Similarly, gas formation contributors such as citric acid, bisulfate, bicarbonate, carbonate and percarbonate can be used as possible disintegration assistants.

Either the tablet disintegrants are mixed in very finely divided form with the other tablet ingredients (which can be finely divided or granular, or else liquid or pasty) prior to molding, or the other tablet ingredients are coated/powdered with the tablet disintegrant.

The solid dishwashing compositions include the customary constituents selected essentially from surfactants, preferably nonionic surfactants, enzymes, amino acids and salts, builders, cobuilders, bleaches, organic acids, hydrotropes, colorant and fragrance materials, further specific excipient and adjunct materials such as for example antioxidants, zeolites, salts, bleach activators, bleach catalysts, photoactive metal oxides, photoactive nanoparticles, photoactivators, enzyme-stabilizing additives, fungicides, bactericides, scale inhibitors, antistats, foam regulators, dye transfer inhibitors, odor binders, polymers, pigments, pH control agents, UV absorbers, optical brighteners, dispersants, complexing agents, preservatives and glass corrosion agents.

Mechanical dishwashing compositions preferably utilize low-suds compounds. These are, in particular, nonionic surfactants, preferably alkoxylated, advantageously ethoxylated, more particularly primary alcohols having preferably 8 to 22 carbon atoms and on average from 1 to 25 mol of ethylene oxide (EO) per mol of alcohol, in each of which the alcohol moiety may be linear or preferably 2-methyl-branched, or may comprise linear and methyl-branched moieties in a mixture as are typically present in oxo process alcohol moieties.

Particular preference, however, is given to alcohol ethoxylates comprising linear alcohol moieties from naturally occurring alcohols having 10 to 20 carbon atoms, for example from coconut alcohol, palm alcohol, tallow fat alcohol of oleyl alcohol, and an average of 2 to 18 EO per mole of alcohol. The degree of ethoxylation is a statistical average which may be a whole number or a fraction for any one specific product. The alcohol ethoxylates can be narrow range or broad range ethoxylates. This class of products includes the Genapol®™ brands from Clariant GmbH.

A further class of preferably used nonionic surfactants, used either as sole nonionic surfactant or in combination with other nonionic surfactants, is that of alkoxylated, preferably ethoxylated or ethoxylated and propoxylated fatty acid alkyl esters, preferably having 1 to 4 carbon atoms in the alkyl chain, more particularly fatty acid methyl esters.

A further class of nonionic surfactants which is advantageously usable comprises alkylpolyglycosides (APGs), for example those of the general formula RO(G)_{z}, where R is a linear or branched, more particularly 2-methyl-branched, saturated or unsaturated, aliphatic radical having 8 to 22 and preferably 12 to 18 carbon atoms and G is a glycose unit having 5 or 6 carbon atoms, preferably glycose. The degree of glycosation z is between 1 and 4, preferably between 1 and 2. Preference is given to using linear alkylpolyglycosides, i.e., alkylpolyglycosides consisting of a glycose residue and an n-alkyl chain.

Nonionic surfactants of the amine oxide type, for example N-cocoalkyl-N,N-dimethylamine oxide and N-tallowalkyl-N,N-dihydroxyethylamine oxide, and of the fatty acid alkanolamide type may also be suitable. The amount of these nonionic surfactants is preferably not more than that of the ethoxylated fatty alcohols, more particularly not more than half thereof.

Further suitable are nonionic surfactants of the general formula

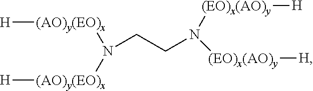

which can have alternating ethylene oxide and alkylene oxide units, preferably propylene oxide units, and the EO and AO units can form a random distribution or block arrangements. Preference among these is in turn given to surfactants having EO-AO-EO-AO blocks, where in each case one to ten EO or AO groups are attached to each other before there is a block of the respective other groups and the indices x and y independently represent integers from 1 to 10.

Nonionic surfactants which can be used with particular advantage are available for example under the trade name Genapol® ED from Clariant GmbH.

Further suitable surfactants are polyhydroxy fatty acid amides of the general formula

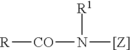

where RCO is an aliphatic acyl radical having 6 to 22 carbon atoms, R¹ is hydrogen or an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known entities which are customarily obtainable by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides further includes compounds of the following formula:

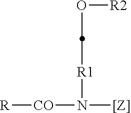

where R is a linear or branched alkyl or alkylene radical having 7 to 12 carbon atoms, R¹ is a linear, branched or cyclic alkyl radical or an aryl radical having 2 to 8 carbon atoms and R² is a linear, branched or cyclic alkyl radical or an aryl radical or an oxyalkyl radical having 1 to 8 carbon atoms, where C₁₋₄-alkyl or phenyl radicals are preferred and [Z] is a linear polyhydroxyalkyl radical the alkyl chain of which is substituted with at least two hydroxyl groups, or alkoxylated, preferably ethoxylated or propoxylated derivatives of this radical. [Z] is preferably obtained through reductive amination of a reduced sugar, for example glucose, fructose, maltose, lactose, galactose, mannose or xylose. The N-alkoxy- or N-aryloxy-substituted compounds can then be converted into the desired polyhydroxy fatty acid amides by reaction with fatty acid methyl esters in the presence of an alkoxide as catalyst.

Particularly preferred nonionic surfactants were proved to be weakly foaming nonionic surfactants which have alternating ethylene oxide and alkylene oxide units, preferably propoxylene oxide units, and the EO and AO units can form random distributions or block arrangements. Among these, preference is in turn given to surfactants having EO-AO-EO-AO blocks where one to ten ED or AO groups are attached to each other to form a block before there is a block formed of the respective other groups.

Preference is given here to rinse agents which as nonionic surfactant(s) surfactants of the general formula

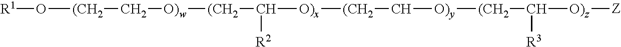

where R¹ is a straight-chain or branched, saturated or mono- or polyunsaturated C₆₋₃₀-alkyl or alkenyl radical, each group R² or R³ is independently —CH₃, —CH₂CH₃, —CH₂CH₂—CH₃, —CH(CH₃)₂, and the indices w, x, y and z are independently integers from 1 to 10. The preferred nonionic surfactants of the formula (IV) are obtainable from the corresponding alcohols R¹—OH and ethylene oxide or alkylene oxide in a conventional manner. The radical R¹ in the general formula (IV) can vary depending on the origin of the alcohol. When natural sources are used, the radical R¹ will have an even number of carbon atoms and generally be unbranched, preference being given to the linear radicals from naturally occurring alcohols of 12 to 22 carbon atoms, for example from lauryl, coconut, palm fat, palm kernel, stearyl, isostearyl, oleyl, caproyl, capryl, capric, 2-ethylhexyl, isotridecyl, myristyl, cetyl, elaidyl, petroselinyl, arachyl, godoleyl, behenyl, erucyl, or brassidyl alcohol. Examples of alcohols available from synthetic sources are Guerbet alcohols or 2-methyl-branched, or linear and methyl-branched, radicals in a mixture, the form they are typically present in oxo process alcohols. Preferably, the radical R¹ in formula (IV) is alkyl of 6 to 30 and preferably 8 to 18 carbon atoms. The alkylene oxide unit present in the preferred nonionic surfactants in alternation with the ethylene oxide unit may be butylene oxide in particular as well as propylene oxide. But other alkylene oxides in which R² and R³ are independently selected from —CH₂CH₂—CH₃ or —CH(CH₃)₂ are also suitable. Preferably, R² and R³ are each methyl. Nonionic surfactants which can be used to particular advantage are for example available under the name Genapol® EP 2564 and Genapol® EP 2584 from Clariant GmbH.

The preferred additional surfactants used are weakly foaming nonionic surfactants. Particular preference is given to the inclusion of a nonionic surfactant having a melting point above room temperature. Preferred compositions are accordingly characterized in that they contain nonionic surfactant(s) having a melting point above 20° C., preferably between 25 and 50° C. and more particularly between 25 and 45° C. In addition to the nonionic surfactants having melting or softening points in the abovementioned temperature range, nonionic surfactants are suitable that can be solid or highly viscous at room temperature. When nonionic surfactants that are highly viscous at room temperature are used, it is preferable for these to have a viscosity above 20 Pas, preferably 35 Pas and more particularly above 40 Pas. Preference is also given to nonionic surfactants that have a waxy consistency at room temperature.

Preferred room temperature solid nonionic surfactants belong to the groups of alkoxylated nonionic surfactants, more particularly ethoxylated primary alcohols and mixtures of these surfactants with structurally complicatedly built surfactants, such as polyoxypropylene/polyoxyethylene/polyoxypropylene (PO/EO/PO) surfactants. Such (PO/EO/PO) nonionic surfactants are also notable for good foam control.

In a preferred embodiment, the nonionic surfactant having a melting point above room temperature is an ethoxylated nonionic surfactant formed from the reaction of a monohydroxy alcohol or alkylphenol having 6 to 20 carbon atoms with at least 12 mol, preferably 15 mol and more particularly at least 20 mol of ethylene oxide per mole of alcohol or alkylphenol.

A particularly preferred room temperature solid nonionic surfactant is obtained from a straight-chain C₁₈₋₂₀ fatty alcohol, preferably a C₁₈ alcohol and at least 12 mol, preferably 15 mol and more particularly at least 20 mol of ethylene oxide.

Preference is given particularly to ethoxylated nonionic surfactant(s) formed from C₆₋₂₀ monohydroxyalkanols or C₆₋₂₀ alkylphenols or C₆₋₂₀ fatty alcohols and more than 12 mol, preferably more than 15 mol and more particularly more than 20 mol of ethylene oxide per mole of alcohol.

The nonionic surfactant preferably additionally contains propylene oxide units in the molecule. Such PO units preferably comprise up to 25% by weight and more particularly up to 15% by weight of the total molar mass of the nonionic surfactant. Particularly preferred nonionic surfactants are ethoxylated monohydroxyalkanols or alkylphenols which additionally include polyoxyethylene-polyoxypropylene block copolymer units. The alcohol or alkylphenol moiety of such nonionic surfactant molecules comprises more than 30% by weight, preferably more than 50% by weight and more particularly more than 70% by weight of the total molar mass of such nonionic surfactants. Preferred compositions are characterized in that they contain ethoxylated and propoxylated nonionic surfactants in which the propylene units in the molecule comprise up to 25% by weight, preferably up to 20% by weight and more particularly up to 15% by weight of the total molar mass of the nonionic surfactant.

Further particularly preferred nonionic surfactants to be used having melting points above room temperature contain 40 to 70% of a polyoxypropylene/polyoxyethylene/polyoxypropylene block polymer blend which 75% by weight of a reverse block copolymer of polyoxyethylene and polyoxypropylene having 17 mol of ethylene oxide and 44 mol of propylene oxide and 25% by weight of a block copolymer of polyoxyethylene and polyoxypropylene initiated with trimethylolpropane and containing 24 mol of ethylene oxide and 99 mol of propylene oxide per mole of trimethylolpropane.

Nonionic surfactants usable with particular advantage are available for example under the name Genapol® PF 10 or Genapol® PF 20 from Clariant GmbH.

Preference is also given to a nonionic surfactant of the formula

R₁O[CH₂CH(CH₃)O]x[CH₂CH₂O]y[CH₂CH(OH)R₂]

where R₁ is linear or branched aliphatic hydrocarbyl of 4 to 18 carbon atoms or mixtures thereof, R₂ is linear or branched hydrocarbyl of 2 to 26 carbon atoms or mixtures thereof and x is between 0.5 and 1.5 and y is at least 15.

Further preferably useful nonionics are the end group capped poly(oxyalkylated) nonionic of the formula

R₁O[CH₂CH(R₃)O]x[CH₂]kCH(OH)[CH₂]jR₂]

where R₁ and R₂ are each linear or branched, saturated or unsaturated, aliphatic or aromatic hydrocarbyl of 1 to 30 carbon atoms, R₃ is H or methyl, ethyl, n-propyl, isopropyl, n-butyl, isobutyl or tert-butyl, x is between 1 and 30, k and j are each between 1 and 12, preferably between 1 and 5. When x is ≧2, each R₃ in the above formula can be different. R₁ and R₂ are preferably linear or branched, saturated or unsaturated, aliphatic or aromatic hydrocarbyl radicals of 6 to 22 carbon atoms, and radicals of 8 to 18 carbon atoms are particularly preferred. H, methyl or ethyl is particularly preferred for R₃. Particularly preferred values of x are in the range from 1 to 20 and more particularly from 6 to 15.

As noted above, each R₃ in the general formula (VI) can be different when x is ≧2. As a result, the alkylene oxide unit between the angular parentheses can be varied. When x is 3, for example, the radical R₃ may form ethylene oxide (R₃=H) or propylene oxide (R₃=CH₃) units which can be linked to each other in any order, for example (EO)(PO)(EO), (EO)(EO)(PO), (EO)(EO)(EO), (PO)(EO)(PO), (PO)(PO)(EO) and (PO)(PO)(PO). The value of 3 for x here has been chosen by way of example and can well be larger, in which case the scope for variation increases with increasing x values and includes for example a large number of (EO) groups combined with a small number of (PO) groups, or vice versa.

Particular preference is given to end group capped poly(oxyalkylated) alcohols of the general formula

R₁O[CH₂CH(R₃)O]ₓCH₂CH(OH)CH₂R₂.

where R₁, R₂ and R₃ are each as defined for the previous general formula, x is from 1 to 30, preferably from 1 to 20 and more particularly from 4 to 16. Particular preference is given to surfactants wherein the R₁ and R₂ radicals each have from 8 to 18 carbon atoms, R₃ is H and x is from 6 to 15. Nonionics usable to particular advantage are available for example under the name Genapol® BE 2410, Genapol® BE 2810 or Genapol® BE 2805 from Clariant GmbH.

Preference in the realm of the present invention for use as nonionic surfactants is also given to end group capped surfactants and also nonionics having butyloxy groups. The first group here includes more particularly representatives of the general formula

R₁O[CH₂CH(R₃)O]ₓR₂

where R₁ is linear or branched, saturated or unsaturated, aliphatic or aromatic hydrocarbyl with 1 to 30 carbon atoms, R₂ is linear or branched, saturated or unsaturated, aliphatic or aromatic hydrocarbyl of 1 to 30 carbon atoms which is optionally substituted with 1, 2, 3, 4 or 5 hydroxyl groups and also optionally with further ether groups, R₃ is hydrogen, methyl, ethyl, n-propyl, isopropyl, n-butyl, isobutyl or tert-butyl, and x can assume values between 1 and 40. R₂ may optionally be alkoxylated, in which case the alkoxy group is preferably selected from ethoxy, propoxy and butyloxy groups and mixtures thereof.

Preference here is given to surfactants of the general formula (VIII) in which R₁ is C₉₋₁₁ or C₁₁₋₁₅ alkyl, R₃ is ═H and X assumes a value from 8 to 15, while R₂ preferably is straight-chain or branched saturated alkyl. Particularly preferred surfactants can be described by the formulae C₉₋₁₁(EO)₈C(CH₃)₂CH₂CH₃, C₁₁₋₁₅(EO)₁₅(PO)₆—C₁₂₋₁₄, C₉₋₁₁(EO)₈(CH₂)₄CH₃.

It is further possible to use mixed-alkoxylated surfactants, preference being given to those having butyloxy groups. Such surfactants can be described by the general formula

R₁(EO)ₐ(PO)_{b}(BO)_{c}

where R₁ is linear or branched, saturated or unsaturated, aliphatic or aromatic hydrocarbyl of 1 to 30 and preferably 6 to 2.0 carbon atoms, a represents values between 2 and 30, b represents values between 0 and 30 and c represents values between 1 and 30 and preferably between 1 and 20. Alternatively, the EO and PO groups in this general formula can also be interchanged.

Particularly preferred representatives from this group of surfactants can be described by the formulae C₉₋₁₁(PO)₃(EO)₁₃(BO)₁₅, C₉₋₁₁(PO)₃(EO)₁₃(BO)₆, C₉₋₁₁(PO)₃(EO)₁₃(BO)₃, C₉₋₁₁(EO)₁₃(BO)₆, C₉₋₁₁(EO)₁₃(BO)₃, C₉₋₁₁(PO)(EO)₁₃(BO)₃, C₉₋₁₁(EO)₈(BO)₃, C₉₋₁₁(EO)₈(BO)₂, C₁₂₋₁₅(EO)₇(BO)₂, C₉₋₁₁(EO)₈(BO)₂ and C₉₋₁₁(EO)₈(BO). A particularly preferred surfactant of the formula C₁₃₋₁₅(EO)₉₋₁₀(BO)₁₋₂ is commercially available under the name Plurafac® LF 221. A surfactant of the formula C₁₂₋₁₃(EO)₁₀(BO)₂ can also be used to advantage. Foam inhibitors can be used to suppress foaming during rinsing. Useful foam inhibitors include for example soaps of natural or synthetic origin which have a high proportion of C₁₈-C₂₄ fatty acids. Suitable foam inhibitors of the nonsurfactant type are for example organopolysiloxanes and mixtures thereof with microfine, optionally silanated silica, and also paraffins, waxes, microwaxes and mixtures thereof with silanated silica or bis-fatty acid alkylene diamides. There are also advantages in using mixtures of various foam inhibitors, for example those of silicones, paraffins or waxes. Preferably, the foam inhibitors, more particularly silicone- and/or paraffin-containing foam inhibitors, are bound to a granular carrier substance that is soluble or dispersible in water. Particular preference here is given to mixtures of paraffins and bisstearylethylenediamide.

Preference in the realm of the present invention is given to dishwashing compositions comprising the nonionic surfactant(s) in amounts of 0.5% to 10% by weight, preferably of 1% to 5% by weight and more preferably of 1.5% to 4% by weight, all based on the final composition.

In conjunction with the nonionic surfactants mentioned it is also possible to use anionic, cationic and/or amphoteric surfactants, although these, on account of their foaming characteristics, are only of minor importance for mechanical dishwashing and are usually used only in amounts below 10% by weight, usually even below 5% by weight, for example in the range from 0 to 2.5% by weight, all based on the composition.

To improve detachment of protein- or starch-containing food residues, it may be preferable to use enzymes such as proteases, amylases, lipases or cellulases, for example proteases such as BLAP™ 140 from Henkel, Optimase™-M-440, Optimase™-M-330, Opticlean™-M-375, Opticlean™-M-250 from Solvay Enzymes, Maxacal™ CX 450 000, Maxapem™ from Ibis, Savinase™ 4.0 T, 6.0 T, 8.0 T from Novo or Experase™ T from Ibis; amylases such as Termamyl™ 60 T from Novo, Amylase-LT™ from Solvay Enzymes or Maxamyl™ P 5000, CXT 5000 or CXT 2900 from Ibis; lipases such as Lipolase™ 30 T from Novo; cellulases such as Celluzym™ 0.7 T from Novo Nordisk. Enzymes can be incorporated in the compositions of the present invention in an amount of 0.1% to 5% by weight and preferably 1% to 3% by weight, based on the entire dishwashing composition.

Useful amino acids include synthetic or naturally occurring amino acids obtainable for example by hydrolysis from vegetable or animal proteins such as collagen, keratin, casein, elastin, soy protein, wheat gluten or almond protein.

Preference is given to alpha-amino acids, for example serine, threonine, ornithine, arginine, lysine, asparagine, glutamine, phenylalanine or tyrosine, but more particularly glycine, alanine, valine, leucine and isoleucine. Particular preference is given to glycine and its alkali metal or ammonium salts, e.g., sodium glycinate.

In addition to the amino acids, the dishwashing compositions of the present invention may also include their alkali metal, alkaline earth metal or ammonium alts, more particularly the sodium salts.

By varying the ratio of the amino acids to their salts it is possible to set a particular desired pH as easily as with the bicarbonate/carbonate system. However, with regard to limescale inhibition, the alkali carrier system of amino acid/amino acid salt is distinctly superior to the bicarbonate/carbonate system.

Amino acids or amino acid salts are present in the compositions of the present invention in amounts of 0.5% to 60% by weight and preferably 10% to 50% by weight. Mixtures of various amino acids or amino acid salts can also be used here. Optionally, carbonate and/or bicarbonates, more particularly alkali metal carbonates and/or bicarbonates can be present in amounts of up to 15% by weight, based on the entire dishwashing composition. Preferably, however, the dishwashing compositions of the present invention are free of carbonates and/or bicarbonates. Similarly, the use of high-alkali metasilicates, for example sodium metasilicate, is preferably omitted; disilicates, by contrast, may optionally be present in the form of their alkali metal salts in amounts of 0.1% to 20% by weight, based on the entire dishwashing composition.

Possible builder components, which have the actual function of complexing hardness formers in water and of keeping precipitated lime in dispersed form in the wash liquor to thereby inhibit limescale formation, include for example organophosphonic acids and their salts, crystalline sheet silicates, zeolites, di- and polyfunctional organic carboxylic acids and their salts, oxidized starch and polycarboxylic acids or polycarboxylates. The phosphates which used to be used, e.g., pentasodium triphosphate, which can likewise be included in principle, are preferably dispensed with for ecological reasons.

Preferred builder components are di- or polyfunctional organic carboxylic acids and their salts, more particularly citric acid and its salts and/or synthetic polycarboxylic acids or polycarboxylates, which are present in a total amount of 1% to 60% by weight and preferably 10% to 40% by weight, based on the entire dishwashing composition.

Synthetic polycarboxylic acids and polycarboxylates refers to the synthetic polymers/salts of the chain growth addition polymerization products of unsaturated carboxylic acids or their salts, which include for example polyacrylic acid, polymethacrylic acid, polymaleic acids or copolymers of acrylic acid with maleic acid or maleic anhydride.

Suitable polyacrylates are for example Alcosperse™ 102, 104, 106, 404, 406 from Alco, Acrysole™ A N1, LMW 45 N, LMW 10 N from Norsohaas, Degapas™ from Degussa; suitable copolymers of polyacrylic acid and maleic acid are for example Sokalan™ cP 5, CP 7 from BASF, Acrysol™ QR 1014 from Norsohaas, Alcosperse™ 175 from Alco.

The dishwashing compositions may further contain bleaching agents based on oxygen, more particularly perborates and/or percarbonates in an amount of 0.5% to 20% by weight and preferably up to 10% by weight, based on the entire dishwashing composition.

Of particular importance are sodium perborate tetrahydrate (NaBO₂.H₂O₂.3H₂O), sodium perborate monohydrate (NaBO₂.H₂O₂) and the peroxycarbonate (Na₂CO₃.1.5H₂O₂). Further useful bleaching agents are for example peracidic salts of organic acids, such as perbenzoates or salts of diperdodecanedioic acid. Bleach activators are optionally also present. Suitable bleach activators are more particularly N-acyl and O-acyl compounds, preferably tetraacylated diamines such as tetraacetylethylenediamine (TAED). The compositions of the present invention contain such customary bleach activators in an amount of 0.1% to 10% by weight and preferably 1% to 5% by weight. The compositions of the present invention may optionally also contain agents which detach active chlorine, e.g., trichloroisocyanuric acid; preferably, however, they are free of agents which detach active chlorine.

Preference for use as acids is given more particularly to organic acids, preferably short-chain aliphatic monocarboxylic acids, hydroxy carboxylic acids and dicarboxylic acids. Examples of aliphatic monocarboxylic acids and dicarboxylic acids are C₁ to C₆ alkyl and alkenyl acids, such as glutaric acid, succinic acid, propionic acid, adipic acid and acetic acid. Examples of hydroxy carboxylic acids are hydroxyacetic acid and citric acid.

The polyesters of the present invention can also be used in separate rinse formulations.

A particularly preferred embodiment comprises solid dishwashing formulations with integrated rinse, containing in addition to the polyesters of the present invention 0% to 50% by weight of phosphates, preferably pentasodium triphosphate, 0% to 5% by weight of phosphonates, 0% to 50% by weight of sodium citrate, 0% to 10% by weight of sodium polycarboxylates, 0% to 40% by weight of sodium carbonate, 0% to 25% by weight of sodium bicarbonate, 0% to 30% by weight of sodium disilicate, 5% to 15% by weight of bleach, preferably sodium perborate, 1% to 5% by weight of bleach activator, preferably TAED, 1% to 5% by weight of enzymes, preferably proteases and amylases, 1% to 10% by weight of nonionic surfactants, preferably fatty alcohol alkoxylates and polyethylene glycol 0% to 2% by weight of paraffins, 0% to 1% by weight of silver protection, fragrance and colorant materials.

The examples which follow are intended to elucidate the subject matter of the invention more particularly without limiting it to the examples.

### EXAMPLES

### 1.) General Synthesis Prescription for Preparing Nonionic Polyesters 1 to 8

A 2 L four-neck flask equipped with KPG stirrer, internal thermometer, Vigreux column, distillation bridge and Anschütz-Thiele adapter was initially charged with the starting materials dimethyl terephthalate (DMT), 1,2-ethanediol (EG) and/or 1,2-propanediol (PG) and anhydrous sodium acetate (NaOAc) (amounts see Table 1).

The mixture was gradually heated on an oil bath until it had completely melted at about 125° C. Starting at about 130° C., the transesterification ensued, and methanol distills off. About 15 minutes after the start of the distillation titanium tetraisopropoxide (IPT) was added at a temperature of 160° C. After a total of about 2 hours, the transesterification was discontinued at 200° C. and the oil bath was lowered.

Then, the corresponding polyethylene glycols (PEG), methyl polyglycols (MPEG) and, where appropriate, polyfunctional compounds (PFV) were added (amounts see Table 1) to the melt and heating was continued up to about 215° C. Thereafter, vacuum was applied and lowered to 10 mbar within 30 minutes. This was followed by postcondensation at 215° C./10 mbar for about one further hour, during which the amount of distillate generated decreased markedly. Finally, the oil bath is lowered, the apparatus is separated from the vacuum and is vented with nitrogen. The melt was discharged while still hot.

TABLE 1
starting materials and starting amounts used for preparing
polyesters 1 to 8

| Starting | | | | | | | | |
|---|---|---|---|---|---|---|---|---|
| material | Polyester 1 | Polyester 2 | Polyester 3 | Polyester 4 | Polyester 5 | Polyester 6 | Polyester 7 | Polyester 8 |
| DMT/mol | 0.7 | 0.5 | 0.15 | 0.25 | 0.16 | 0.25 | 0.16 | 0.16 |
| EG/mol | 1.35 | 0.28 | 0.3 | 0.48 | 0.3 | 0.48 | 0.3 | 0.3 |
| PG/mol | — | 0.68 | — | — | — | — | — | — |
| PEG type | 6000 | 6000 | 6000 | 4000 | 6000/200 | 3000 | 6000 | 6000 |
| PEG/mol | 0.18 | 0.13 | 0.04 | 0.065 | 0.04/0.004 | 0.07 | 0.04 | 0.04 |
| MPEG type | — | 750/2000 | 750/2000 | 750/2000 | — | — | — | — |
| MPEG/mol | — | 0.05/0.02 | 0.015/0.007 | 0.024/0.011 | — | — | — | — |
| IPT | 0.0007 | 0.0005 | 0.0001 | 0.0002 | 0.00016 | 0.0002 | 0.0002 | 0.0015 |
| NaOAc | 0.004 | 0.006 | 0.0009 | 0.0015 | 0.0009 | 0.0015 | 0.0009 | 0.0002 |
| PFV type | — | — | — | — | — | — | A | B |
| PFV/mol | — | — | — | — | — | — | 0.01 | 0.0015 |

A 2,2-bis(hydroxymethyl)propionic acid
B pentaerythritol
DMT dimethyl terephthalate
EG 1,2-ethanediol
PG 1,2-propanediol
PEG polyethylene glycol (200, 1500, 3000, 4000, 6000)
IPT titanium tetraisopropoxide
NaOAc sodium acetate
PVF polyfunctional compounds
MPEG methyl polyglycols

### II.) Performance Tests of Nonionic Polyesters 1 to 8

II.a) Determination of Flow Factor ff_{c} from Measurements in Ring Shear Instrument

The flow properties of the soil release polyesters prepared are best assessed using the dimensionless flow factor ff_{c}, which is defined as the ratio of consolidating stress σ₁ to the bulk solid stress σ_{c}.

ff_{c}=σ₁/σ_{c}

The bulk solid to be tested was initially consolidated by the consolidating stress σ₁. The sample was then subjected to an increasing compressive stress. The stress causing the sample of bulk solid to break (i.e., to flow) is the bulk solid stress σ_{c}.

The greater the flow factor ff_{c}, the better the flow properties possessed by the bulk material. The following classification by Jenike was used:

ff_{c}<1 non-flowing

1<ff_{c}<2 very cohesive, non-flowing

2<ff_{c}<4 cohesive

4<ff_{c}<10 easy-flowing

10<ff_{c} free-flowing

The reported flowabilities were determined using a ring shear instrument of the RST-01.pc type from Dr. Dietmar Schulze Schüttgutmesstechnik. The measurement and evaluation was carried out automatically (computer controlled).

### II.b) Investigation of Soil Release Effect:

The soil release polyesters of the present invention were tested for their soil release effect using the “Dirty Motor Oil Test”. To this end, the polymers were admixed to the IEC-A test laundry detergent in a concentration of 1% (active substance) and subsequently a wash liquor was prepared at a laundry detergent concentration of 6 g/L. The wash liquor was used to prewash the two standard test cloths polyester/cotton WFK 20A and polyester WFK 30A. The cloths were subsequently dried and stained with dirty motor oil. After allowing the dirty motor oil to soak in for one hour at room temperature, the stained cloth specimens were rewashed under the same washing conditions with the IEC-A test laundry detergent containing the polymers of the present invention. After drying, the reflectance of the test cloths was measured. For comparison, stained test cloths were washed under the same test conditions but without an addition of the soil release polymers to the test laundry detergent and their reflectance was determined.

The differences between the reflectances from the washes with soil release polymer and the washes without soil release polymer indicate the soil release effect achieved. The soil release effect of two commercially available, granulated soil release polymers was investigated as benchmark.

The detailed washing conditions are shown in Table 2.

TABLE 2
Washing conditions

| | |
|---|---|
| Washing machine: | Linitest |
| Water hardness: | 15° German hardness |
| Liquor ratio | 1:40 |
| Washing temperature: | 40° C. |
| Washing time: | 30 min |
| Laundry detergent concentration: | 6 g/l |

The composition of the IEC-A test laundry detergent used is shown in Table 3.

TABLE 3
IEC-A washing powder (phosphate-free, with bleach)

| | |
|---|---|
| alkylbenzenesulfonate, sodium salt | 8.8% |
| C₁₂₋₁₈ alcohol ethoxylate with 7 EO | 4.7% |
| soap | 3.2% |
| DC2-4248S foam inhibitor, Dow Corning | 3.9% |
| zeolite 4A | 28.3% |
| sodium carbonate | 11.6% |
| polycarboxylate (Sokalan ® CP5) | 2.4% |
| sodium silicate | 3.0% |
| carboxymethylcellulose | 1.2% |
| phosphonate (Dequest ® 2066) | 2.8% |
| optical brightener | 0.2% |
| sodium sulfate | 6.5% |
| protease Savinase ® 8.0, Novo Nordisk | 0.4% |
| TAED | 5.0% |
| sodium percarbonate | 18.0% |

### II.c) Results of Performance Tests

TABLE 4
soil release effects, molecular weights, melting points and
flow properties of soil release polyesters 1 to 8 compared with
the commercially available products Repel-O-Tex ® SRP 6
and Sokalan ® SR 100

| | DMO 1 | DMO 2 | GPC Mₚ | m.p. | ff_{c} |
|---|---|---|---|---|---|
| Polyester 1 | 5.1 | 4.3 | 9970 | 57 | 18 |
| Polyester 2 | 4.5 | 5.0 | 8930 | 58 | 16 |
| Polyester 3 | 4.9 | 1.2 | 7070 | 55 | 16 |
| Polyester 4 | 5.1 | 2.5 | 7750 | 52 | 14 |
| Polyester 5 | 5.1 | 4.8 | 11360 | 57 | 17 |
| Polyester 6 | 4.1 | 5.2 | 8540 | 49 | 10 |
| Polyester 7 | 2.3 | 2.0 | 7420 | 58 | 17 |
| Polyester 8 | 7.3 | 6.0 | 8340 | 57 | 16 |
| Repel-O-Tex SRP 6 | 7.9 | 3.8 | — | 48 | 4 |
| Sokalan SR 100 | 3.1 | 0.7 | — | — | 4 |

DMO 1: soil release effect versus dirty motor oil on WFK 20A test cloth
DMO 2: soil release effect versus dirty motor oil on WFK 30A test cloth
GPC: gel permeation chromatography
m.p.: melting point in [° C.] (defined as peak maximum from differential scanning calorimetry)
ff_{c}: flow factor determined by measurements in ring shear instrument

### Schedule of Commercial Products Used:

| | |
|---|---|
| Repel-O-Tex ® SRP 6 (from Rhodia) | nonionic soil release polyester in |
| | granulate form, about 99% active |
| | substance |
| Sokalan ® SR 100 (from BASF) | nonionic soil release polyester in |
| | granulate form, about 100% active |
| | substance |

### Measurement of Melting Points:

The melting range of the substances was determined by differential scanning calorimetry on a Mettler Toledo DSC 821e. The measurement took place in a temperature interval between 10° C. and 80° C. at a heating rate of 5 K per minute in an aluminum crucible. The melting points reported correspond to the peak maximum of the softening curve recorded.

### Determination of Molecular Weights:

The molecular weight distribution was determined by gel permeation chromatography (GPC). The measurement was carried out against narrowly distributed polystyrene sulfonate standards using 45:55 w/w acetonitrile/water as solvent mixture. A Suprema 30 column was used for resolution. 100 μl of a solution of the concentration 1.000 g/l was injected and eluted at a flow rate of 0.8 ml/min. The reported molecular weights were determined as peak maximum Mₚ of the distribution curve measured.

1. An additive for a washing and cleaning composition, obtained by condensation polymerization of an
a) aromatic dicarboxylic acid and/or C₁-C₄-alkyl esters thereof,
b) ethylene glycol,
c) 1,2-propylene glycol,
d) polyethylene glycol having an average molar mass [Mₙ] of 5000 to 8000 g/mol,
e) C₁-C₄-alkyl polyalkylene glycol ether having an average molar mass of 200 to 5000 for the polyalkylene glycol ether, and
f) a polyfunctional compound,
wherein the molar ratios of components b), c), d), e) and f) based in each case on 1 mol of component a) are from 0.1 to 4 mol for component b), from 0 to 4 mol for component c), from 0.1 to 0.5 mol for component d), from 0 to 0.5 mol for component e) and from 0 to 0.25 mol for component f); and characterized by a molecular weight with a peak maximum Mp of 6000 to 14 000 g/mol.

2. An additive for a washing and cleaning composition according to claim 1 wherein the molar ratios of components b), c), d), e) and f) based in each case on 1 mol of component a) are from 1.0 to 2.5 mol for component b), from 0 mol for component c), from 0.1 to 0.4 mol for component d), from 0 to 0.25 mol for component e) and from 0 to 0.2 mol for component f).

3. An additive for a washing and cleaning composition according to claim 1 wherein the molar ratios of components b), c), d), e) and f) based in each case on 1 mol of component a) are from 1.0 to 2.5 mol for component b), from 0 mol for component c), from 0.1 to 0.3 mol for component d), from 0 to 0.2 mol for component e) and from 0 to 0.1 mol for component f).

4. An additive for a washing and cleaning composition according to claim 1 wherein component a) is terephthalic acid and/or dimethyl terephthalate.

5. An additive for a washing and cleaning composition according to claim 1 wherein polyethylene glycol d) has an average molar mass [Mn] of 5000 to 6000.

6. An additive for a washing and cleaning composition according to claim 1, having a flow factor ffc of more than 8.

7. An additive for a washing and cleaning composition according to claim 1, having a melting point of above 40° C.

8. A washing and cleaning composition comprising an additive according to claim 1.

9. An additive for a washing and cleaning composition according to claim 1 wherein polyethylene glycol d) has an average molar mass [Mn] of 6000.

10. An additive for a washing and cleaning composition according to claim 1, having a flow factor ffc in the range from 10 to 30.

11. An additive for a washing and cleaning composition according to claim 1, having a melting point of above 50° C.

12. An additive for a washing and cleaning composition according to claim 1, having a melting point of above 55° C.
